(19) United States
(12) Patent Application Publication
(10) Pub. No.: US 2010/0274440 A1
(43) Pub. Date: Oct. 28, 2010

(54) SYSTEM AND METHOD OF MANAGING VEHICLE AND DRIVER INFORMATION

(75) Inventors: Hyun Suk Kim, Daejeon (KR); Dae Sub Yoon, Daejeon (KR); Jong-Woo Choi, Daejeon (KR); Ju Wan Kim, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/679,137

(22) PCT Filed: Sep. 16, 2008
(86) PCT No.: PCT/KR2008/005459

§ 371 Date: Mar. 19, 2010

(30) Foreign Application Priority Data
Nov. 26, 2007 (KR) 10-2007-0120902

(51) Int. Cl. G06F 7/00; H04L 1/18; G06F 11/14; G06N 5/02

(52) U.S. Cl. 701/33; 714/749; 701/35; 706/47; 714/E11.113

(57) ABSTRACT

The present invention relates a system and method of managing vehicle and driver information. According to the present invention, internal status information and external environment information of a vehicle, and a driver's behavior information, are gathered to calculate the driver's workload that is required for careful driving and inform the workload to the driver, which leads to careful driving. Further, the information input to the terminal is sent to an observation center without manual control of the driver so that the observation center can collect and store the information in real time. Furthermore, the driving history, driving habits of the driver, and the amount of consumed fuel can be provided through the terminal and the driver access to the server in the observation center, which improves the driving habits of the driver and provides information about economical driving.

### TECHNICAL FIELD

The present invention relates to a system and a method of managing vehicle and driver information.

The present invention was supported by the IT R&D program of MIC/IITA [2007-S-025-01, Improvement of VDMS (Vehicle & Driver Management System) Technology Development]

### BACKGROUND ART

The term “telematics” means an integrated use of telecommunication and informatics, and is defined as a next generation information supply service for vehicle by combining the IT industry and the automobile industry in which wireless communication, vehicles, terminals, and contents are interconnected to each other.

The telematics service according to the related art provides various services such as traffic and transportation information, emergency measure information, a remote vehicle diagnosis service, Internet, e-mail, day-to-day information, and entertainment by using the wireless communication technology and global positioning system (GPS).

However, the telematics service according to the related art provides the information without considering various information that occur inside/outside of the vehicle and driver's behavior information. In other words, the telematics service according to the related art has a drawback in that it cannot guide the driver to safely drive and provide an efficient driving attitude to the driver by combining and processing information occurring in the inside/outside of the vehicle and the driver's behavior information.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide a system and method of managing vehicle and driver information having advantages of providing a telematics service that is appropriate for a vehicle and driver's situation by collecting information regarding the inside/outside of the vehicle and driver.

### Technical Solution

An exemplary embodiment of the present invention provides a method of managing vehicle and driver information. The method includes: receiving a plurality of internal status information and external environment information of a vehicle, and driver's behavior information collected by an information collecting unit; storing the plural pieces of information by applying a driver's behavior model and a behavior rule previously stored in the received internal status information and external environment information of a vehicle, and driver's behavior information; transmitting the stored information to an observation center and calculating driver's workload on the basis of the stored information; and estimating and managing situation information of the driver and the vehicle on the basis of the calculated driver's workload.

Another exemplary embodiment of the present invention provides a method of managing vehicle and driver information. The method includes: receiving a plurality of internal status information and external environment information of a vehicle, and driver's behavior information, which are collected by an information collecting unit and then stored, from a terminal; creating a driver's behavior model on the basis of the received information; and creating a driver's behavior model and vehicle driving rules on the basis of the received information.

Still another exemplary embodiment of the present invention provides a system of managing vehicle and driver information. The system includes: an information filtering module that calculates information having a predetermined characteristic among a plurality of internal status information and external environment information of a vehicle, and driver's behavior information collected by an information collecting unit; an information storing module that stores the calculated information; a driver's workload calculating module that calculates a driver's workload using the stored information; a situation information estimating module that compares the calculated driver's workload with a value of numerically calculated driver's behavior information to provide the driver's situation information and compares the vehicle external environment information with the numerically calculated value to estimate the driver attention information; and a driver attention information supply module that receives the estimated driver attention information to display to the driver.

Still another exemplary embodiment of the present invention provides a system of managing vehicle and driver information. The system includes: a terminal information managing module that receives internal status information and external environment information of a vehicle, and driver's behavior information collected by an information collecting unit and transmitted from a terminal; an information storing module that stores the received vehicle internal status information, the vehicle external environment, and driver's behavior information; a driving rule creating module that creates and updates the driver's driving tendency and driving rule on the basis of the information stored in the information storing module; a driver's behavior model creating module that calculates a driving pattern that influences the driver's workload on the basis of the information stored in the information storing module and creates the driver's behavior model on the basis of the driving pattern; and a management information supply module that extracts the driver's driving tendency information requested by the driver to display to the driver.

### ADVANTAGEOUS EFFECTS

Therefore, according to the present invention, the internal status information and the external environment information of a vehicle, and the driver's behavior information, are gathered to calculate the driver's workload that is required for careful driving and to inform the workload to the driver, which leads to careful driving.

Further, the information input to the terminal is sent to an observation center without the manual control of the driver so that the observation center can collect and store the information in real time.

Furthermore, the driving history, driving habits of the driver, and the amount of consumed fuel can be provided through the terminal and the driver access to the server in the observation center, which improves the driving habits of the driver and provides information about economical driving.

In addition, since the driver can automatically measure and store driving distances while driving, it is possible to estimate the replacement timing of vehicle supplies according to driving distance and to prevent a vehicle accident by managing trouble information using the vehicle diagnosis information.

### BRIEF DESCRIPTION OF THE DRAWINGS

FIG. 1 is an exemplary diagram showing an environment that provides vehicle and driver information according to an exemplary embodiment of the present invention.

FIG. 2 is an exemplary diagram showing a vehicle and driver information management service according to an exemplary embodiment of the present invention.

FIG. 3 is a configuration diagram showing a vehicle and driver information management system according to an exemplary embodiment of the present invention.

FIG. 4 is a flowchart showing a flow of messages between a terminal and an observation center.

FIG. 5 is an exemplary diagram showing a configuration of a GUI of a terminal provided in a vehicle according to an exemplary embodiment of the present invention.

FIG. 6 is an exemplary diagram showing a configuration of a GUI of an observation center according to an exemplary embodiment of the present invention.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, the terms “-er”, “-or” and “module” described in the specification mean units for processing at least one function and operation, and can be implemented by hardware components, software components, or combinations thereof.

A system and method of managing vehicle and driver information according to an exemplary embodiment of the present invention will now be described in detail with reference to accompanying drawings.

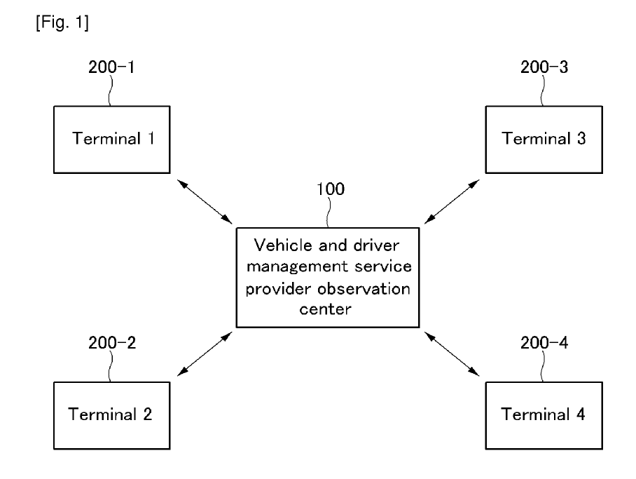

FIG. 1 is an exemplary diagram showing an environment that provides vehicle and driver information according to an exemplary embodiment of the present invention.

As shown in FIG. 1, in order for an observation center that provides a vehicle and driver management service provider observation center (hereinafter referred to as “observation center”) 100 to manage information about a plurality of vehicles and drivers of the vehicles, telematics terminals (hereinafter referred to as “terminals”) 200-1 to 200-4 are connected to the observation center 100 through a mobile communication wireless network to transmit and receive vehicle and driver information. Thereby, a service that is capable of managing vehicles and drivers is provided to vehicle managers and the drivers.

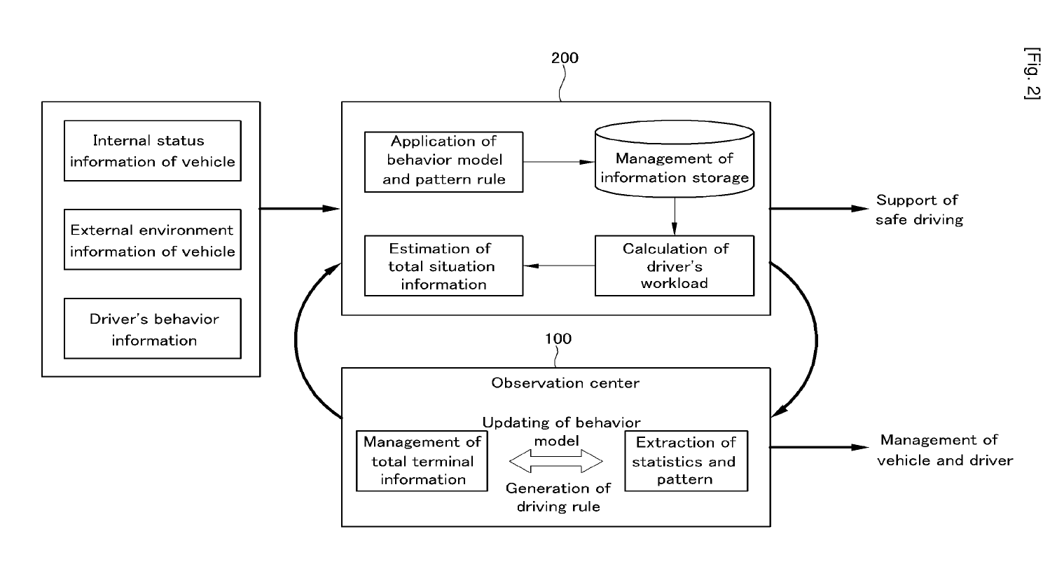

With respect to the above environment, an exemplary embodiment of a service that manages information about the vehicles and the drivers will be described with reference to FIG. 2.

FIG. 2 is an exemplary diagram showing a vehicle and driver information management service according to an exemplary embodiment of the present invention.

As shown in FIG. 2, internal status information and external environment information of a vehicle, and driver's behavior information, are transmitted to the terminals. Here, the internal status information of a vehicle is collected by an information collecting unit such as an electronic control unit (ECU) or a transmission control unit (TCU). Further, the external environment information of a vehicle such as weather information, road information, traffic information, or time information is collected by an information collecting unit such as a global positioning system (GPS), digital multimedia broadcasting (DMB), or a telematics service provider (TSP). Further, the driver's behavior information is collected by information collecting unit such as a microphone or a camera.

The terminal 200 that receives the internal status information and the external environment information of a vehicle, and the driver's behavior information, applies the input information to a behavior model and pattern rule information that are stored in the terminal 200 and then stores them into vehicle and driver information storing modules of the terminal. Further, the terminal 200 calculates driver's workload currently required for the drivers using a driver's workload algorithm stored in the terminal. Furthermore, the terminal 200 compares the calculated driver's workload with the driver's behavior, the vehicle speed, and vehicle status information to totally estimate the status information. Therefore, if the terminal senses that the driver is in a dangerous status, the terminal sends out a warning to the driver to ensure safe driving.

A server installed in the observation center (hereinafter simply referred to as an observation center) is connected to the terminals 200 in real-time to receive and store vehicle, driver, and environment information collected by the terminal and combine them with the previously stored information to extract new statistics and pattern. If the pattern that is newly extracted by the observation center 100 is different from the old behavior model, the observation center updates the behavior model and generates a driving rule.

The observation center 100 transmits the newly generated behavior model and driving rule to the terminal so as to be used in the terminal 200. In this case, the drivers and the vehicle managers log into the server through a web service to retrieve the information stored in the observation center 100.

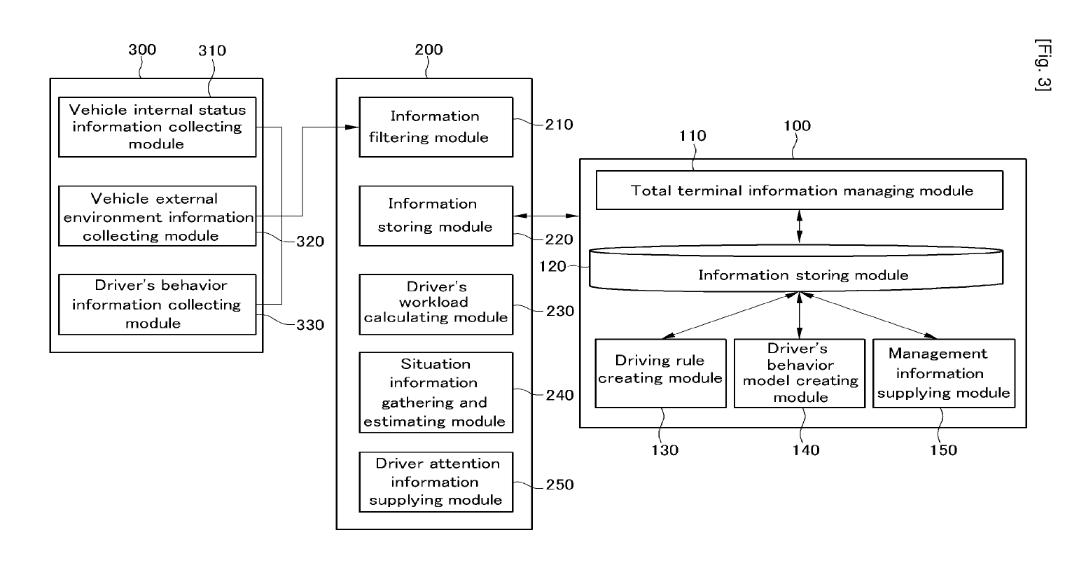

Next, referring to FIG. 3, the configuration of the information collecting unit, terminals 100, and the observation center 100 that provides the vehicle and driver information management service illustrated in FIG. 2.

FIG. 3 is a configuration diagram showing a vehicle and driver information management system according to an exemplary embodiment of the present invention.

As shown in FIG. 3, the vehicle and driver information management system is mainly configured of an information collecting unit that collects the internal status and external environment of a vehicle, and driver's behavior information 300, the terminal 200 receiving the information collected by the information collecting unit 300, providing the information to the drivers, and estimating the status information, and the observation center 100 providing information such that the terminal 200 estimates the status information.

First, the information collecting unit 300 includes a vehicle internal status information collecting module 310, a vehicle external environment information collecting module 320, and a driver behavior information collecting module 330.

The vehicle internal status information collecting module 310 transmits information about the internal status of a vehicle collected by a vehicle electronic control device such as an engine controller, a transmission controller, and a motor controller to the terminal 200 through a controller area network (CAN) or K-Line communication. Here, since the CAN or K-Line communication is well known, a detailed description thereof will be omitted in the exemplary embodiment of the present invention.

The vehicle external environment information collecting module 320 collects the vehicle external environment information such as weather information, traffic accident information, and traffic information that may affect the vehicle running through the wireless Internet, DMB, or GPS to transmit the information to the terminals 200. In this case, the collected vehicle external environment information is transmitted to the terminals 200 through wired communication or wireless communication such as Bluetooth.

The driver's behavior information collecting module 330 collects information about the driver's behavior during driving, such as sleepiness of the driver, the use of a portable phone, conversation with fellow passengers, or front observation, through a microphone or a camera to transmit the collected information to the terminals 200.

Next, the terminal 200 that collects multiple pieces of information from the information collecting unit 300 includes vehicle and driver information (hereinafter simply referred to as information) filtering module 210, an information storing module 220, a driver's workload calculating module 230, a situation information gathering and estimating module 240, and a driver attention information supplying module 250.

The information filtering module 210 selects information having a characteristic that influences the driver to safely drive, among various internal status information and external environment information of a vehicle, and driver's behavior information received from the information collecting unit 300. In this case, data is empirically selected on the basis of information collected from other vehicles that influence the driver of the corresponding vehicle or is previously set when designing the system. However, this invention is not limited thereto.

The information storing module 220 receives the information selected by the information filtering module 210 and stores it. Further, the information storing module 220 stores the driver's workload calculated by the driver's workload calculating module 230.

The driver's workload calculating module 230 considers all information stored in the information storing module 220 to calculate the driver's workload and periodically display the driver's workload that is required during driving on the terminal 200. Further, the calculated driver's workload is transferred and stored in the information storing module 220. Here, the driver's workload may be calculated by giving points to a specific behavior on the basis of the driver's behavior information, but the invention is not limited thereto.

The situation information gathering and estimating module 240 compares the driver's workload displayed on the terminal 200 with the current driver's behavior. Therefore, if the driver does not safely drive, (for example, in spite of a high driving speed, if the driver is sleepy at the wheel), the situation information gathering and estimating module 240 activates a warning light of the terminal 200 in order to give a warning sign. In this case, the current driver's behavior that is compared with the driver's workload is a value found by comparing the driver's behavior information collected from the information collecting unit 300 with a predetermined value and then changing it into a number. Further, the situation information gathering and estimating module 240 periodically checks the vehicle external environment information and the driver's workload among information stored in the information storing module 210, and previously estimates the driver attention value that the driver has to have for safe driving and provides the information to the driver.

The driver attention information supplying module 250 receives the driver attention information that is estimated in the situation information gathering and estimating module 240 and provides the information to the driver through the terminal 200.

Next, the observation center 100 includes a total terminal information managing module 110, an information storing module 120, a driving rule creating module 130, a driver's behavior model creating module 140, and a management information supplying module 150.

The total terminal information managing module 110 receives the internal status information and the external environment information of a vehicle and the driver's behavior information transmitted from the terminal 200, and transmits the information to the information storing module 120 to store the information. Further, the total terminal information managing module 110 transmits information that is created or updated at the observation center 100 to the terminal 200.

When the driver or a manager of the observation center 100 asks the driving tendency information of the driver for some period (for example daily, weekly, or monthly), the management information supplying module 150 extracts the corresponding information from the information storing module 120 and displays it.

The driving rule creating module 130 creates the driving tendency of the driver and the driving rule on the basis of the vehicle and driver information for every driver because a large amount of vehicle and driver information is stored. Further, the driving rule creating module 130 creates and upgrades general rules and information with regard to a malfunction of a vehicle, driving history, or supply replacement information.

The driver's behavior model creating module 140 calculates the driving pattern that affects the driver's workload and creates the driver's behavior pattern to ensure safe driving on the basis of the driving pattern. The created driver's behavior model is supplied to the driver together with the driver's workload.

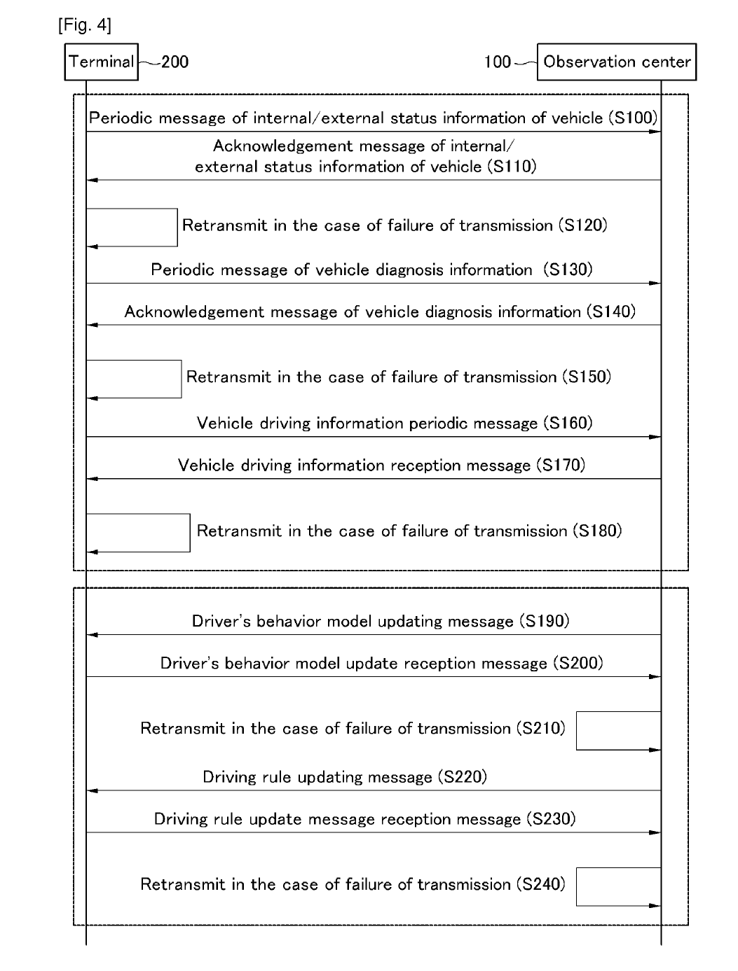

Next, referring to FIG. 4, the flow of a message for transmitting/receiving information between the terminals 200 and the observation center 100 will be described.

FIG. 4 is a flowchart showing a flow of messages between a terminal and an observation center.

A message that is transmitted/received between the terminal 200 and the observation center 100 is divided into a message for transmitting information created in the terminal 200 to the observation center 100 and a message that is transmitted to the terminal 200 with information created in the observation center 100. In FIG. 4, even though it is shown that the messages are transmitted/received according to the passage of time for convenience sake, the invention is not limited thereto.

At first, the message flow in which the information created in the terminal 200 is input to the message to be sent to the observation center 100 will be described. The terminal 200 periodically includes the internal status information and the external environment information of a vehicle and the driver's behavior information stored in the information storing module 220 in the vehicle internal/external status information message to transmit them to the observation center 100 (S100). In this case, the period when the terminal 200 transmits the message to the observation center 100 is varied depending on the system design.

The observation center 100 that receives the internal status information and the external environment information of a vehicle and driver's behavior information from the terminal 200 transmits an acknowledgement message of vehicle internal/external status information that represents that the information to the terminal 200 is received (S110). In this case, if the terminal 200 does not receive the acknowledgement message of internal/external status information of a vehicle from the observation center 100 within a predetermined time, the terminal 200 repeatedly transmits the vehicle internal/external status information message to the observation center 100 (S120).

If the terminal 200 receives the vehicle internal status information from the information collecting unit 300, the terminal 200 periodically creates the vehicle diagnosis information message to transmit to the observation center 100 (S130). Here, the vehicle diagnosis information includes vehicle problems and malfunction information. If the observation center 100 receives the vehicle diagnosis information message, the observation center transmits the vehicle diagnosis information reception message to the terminal 200 (S140). In this case, as when the terminal 200 transmits/receives the vehicle internal/external status information message, if the terminal 200 does not receive the vehicle diagnosis information reception message from the observation center 100, the terminal 200 determines that the message transmission has failed and retransmits the vehicle diagnosis information message to the observation center 100 predetermined times (S150).

Further, the terminal 200 periodically input the vehicle driving information in the message to transmit it to the observation center 100 (S160). The observation center 100 transmits a vehicle driving information acknowledgement message that informs the terminal 200 of the acknowledgement of the vehicle driving information message from the terminal 200 (S170). In this case, if the terminal 200 does not receive the vehicle driving information acknowledgement message from the observation center 100 within a predetermined time, the terminal 200 determines that the transmission of the vehicle driving information message has failed, and retransmits the message to the observation center 100 (S180).

Next, a method of including the information created or updated by the observation center 100 in a message to transmit it to the terminal 200 will be described with a driver's behavior model updating message and a driving rule updating message as examples. The observation center 100 loads the driver's behavior model information updated by the driver's behavior model creating module 140 in the driver's behavior model updating message to transmit to the terminal 200 (S190). Similar to this, the observation center 100 inputs the driving rule updating information updated by the driving rule creating module 130 in a message to transmit it to the terminal 200 (S220).

Here, the driver's behavior model information is updated, and the driver's behavior model creating module 140 extracts the driver's behavior pattern on the basis of the internal status information and the external environment information of a vehicle, and the driver's behavior information collected and transmitted by the terminal 200 and the information already stored in the observation center 100. In this case, if the extracted pattern is different from the old behavior pattern, the driver's behavior model creating module 140 updates the driver's behavior model information. Further, if the driving rule determination algorithm for the driving pattern of the driver is changed, the observation center 100 updates the driving rule.

If the terminal 200 receives the driver's behavior model updating message or a driving rule updating message, the terminal 200 creates a driver's behavior model updating acknowledgement message or a driving rule acknowledgement message to transmit it to the observation center 100 (S200 and S230). If the observation center 100 does not receive the driver's behavior model updating reception message or the driving rule acknowledgement message from the terminal 200, the observation center 100 determines that the message transmitted from the observation center has not been successfully transmitted to the terminal 200, and retransmits the information a predetermined number of times (S210 and S240). In other words, after the observation center 100 transmits the message to the terminal 200, the observation center 100 operates a timer. Therefore, if the observation center 100 does not receive the acknowledgement message from the terminal before the timer value has passed, the observation center 100 determines that the message transmission has failed.

As described, the message format that is transmitted/received between the terminal 200 and the observation center 100 may be binary or extensible markup language (XML). However, the invention is not limited thereto.

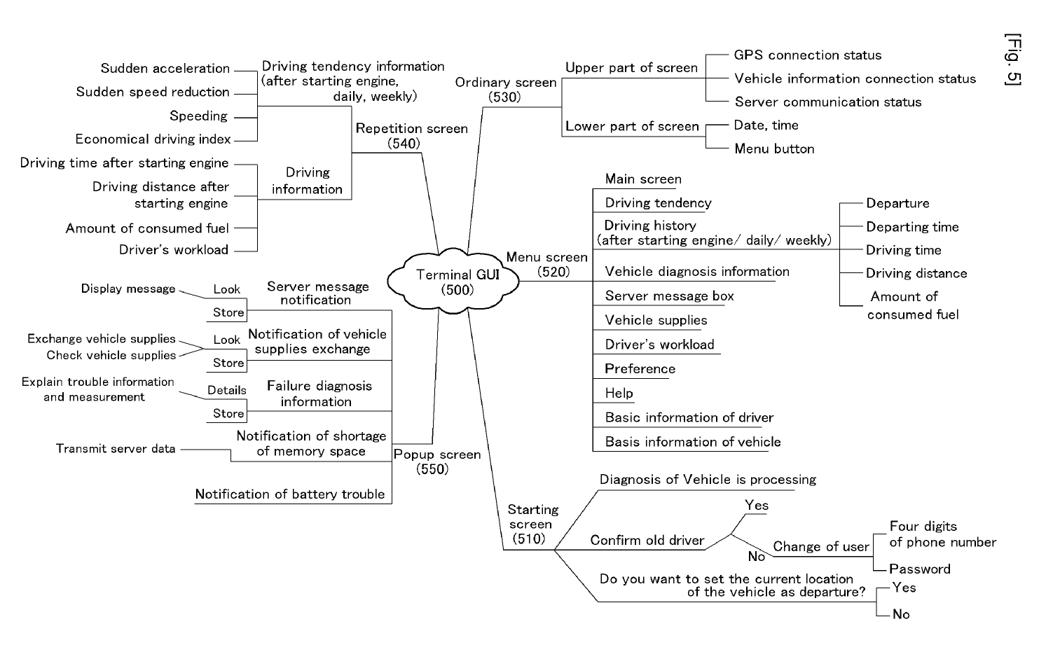

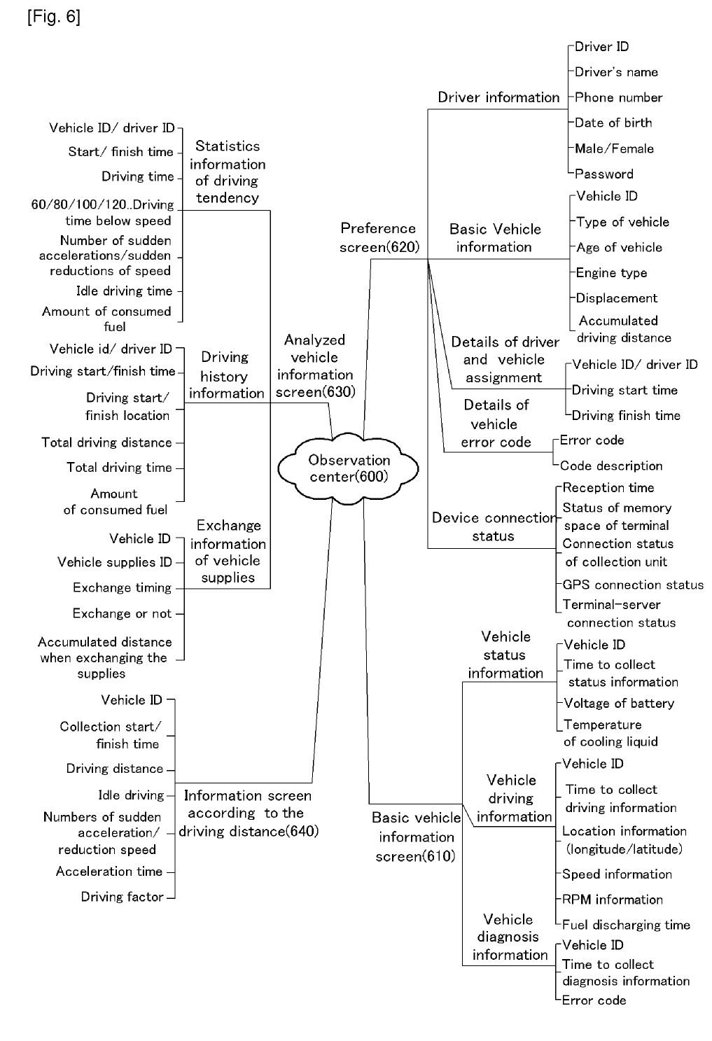

Next, for when the vehicle and driver information management service is supplied to the driver, a configuration of a graphic user interface (GUI) of the terminal 200 and the observation center 100 will be described with reference to FIG. 5 and FIG. 6.

FIG. 5 is an exemplary diagram showing a configuration of a GUI of a terminal provided in a vehicle according to an exemplary embodiment of the present invention.

The GUI of the terminal 200 is configured by a starting screen, an ordinary screen, a repetition screen, a popup screen, and a menu screen so as to provide vehicle status and driver's driving information. When the driver starts an engine of the vehicle, the terminal 200 provided in the vehicle is driven to display the starting screen 510, as shown in FIG. 5. At the same time, the diagnosis of the vehicle is started and a message that indicates that the vehicle diagnosis is being processed is displayed on the screen.

In this case, if a plurality of drivers drive the same vehicle, the vehicle driving information for every driver needs to be checked and analyzed. For this purpose, according to an exemplary embodiment of the present invention, if the current driver is different from the former driver, a change of user function is performed.

Similar to this, in the case of a business vehicle, the driving record needs to be automatically prepared. According to the vehicle and driver information management system, if the vehicle stops and then restarts during driving, whether the location where the engine has started is set as the departure is displayed on a screen so as to be selected by a new driver, thereby maintaining the information regarding the departure location.

When the starting screen 510 is finished, the ordinary screen 530 is displayed through the terminal 200. Date, time, a menu button, GPS connection status, connection status with the vehicle information collecting unit, and connection status with the observation center 100 are always displayed on the upper part and lower part of the ordinary screen 530. According to the exemplary embodiment of the present invention, since the internal/external information of a vehicle needs to be collected in real time, the connection status information is displayed on the terminal 200.

The repetition screen 540 is disposed in the center of the ordinary screen, and divides the information regarding the driver's driving pattern into the driving tendency information and driving information to repeatedly show the information to the driver. Here, the driving tendency information refers to information including sudden acceleration, sudden speed reduction, speeding, and economical driving index according to a period, for example, after starting the engine, daily or weekly. The driving information refers to information including a running time after starting the engine, a driving distance after starting the engine, the amount of consumed fuel, or the driver's workload.

The popup screen 550 is displayed to notify a dangerous status (alarm) to the driver. That is, when the emergency message transmitted from the observation center 100 is notified to the driver or the vehicle supplies need to be replaced, the popup screen is activated to be displayed to the driver. Further, the popup screen informs the trouble information when the battery does not work, or the vehicle has a maintenance problem. Further, the popup screen notifies that the memory space for storing the vehicle and driver information is insufficient in the terminal 200.

The menu screen 520 is displayed when the menu button of the ordinary screen 530 is selected. The menu screen allows the driver to retrieve the vehicle and driver information through the terminal 200. The menu screen 520 is configured by driving tendency representing the driver's driving tendency, driving history, vehicle diagnosis information, a server message box, extendable replacement information, driver's workload, a preference bar, a help bar, driver's basic information, and vehicle basic information. However, this invention is not limited thereto.

Next, the GUI configuration of the observation center 100 will be described with reference to FIG. 6.

FIG. 6 is an exemplary diagram showing a configuration of a GUI of an observation center according to an exemplary embodiment of the present invention.

The driver or the vehicle manager is allowed to access to the server in the observation center 100. By doing so, when the user logs in to access to the server, the user needs to input a password to protect the information of the observation center 100. Accordingly, if the user that logs into the observation center 100 is the driver, the retrievable information is limited as compared with the vehicle manager.

The GUI of the observation center 100 may be configured by an environment information screen 620, a basic vehicle information screen 610, an analyzed vehicle information screen 630, and a driving distance information screen 640 so as to provide the vehicle status and driving information to the personal driver and the vehicle manager. However, this invention is not limited thereto.

The environment information screen 620 displays driver information that identifies the driver, vehicle identifying information, a driver, vehicle allocation details, vehicle trouble code details, and connection status of devices in the vehicle when the vehicle is used for business purposes. Here, the driver information includes driver's ID, driver's name, mobile phone number, date of birth, sex, and password.

The vehicle basic information includes vehicle ID, model of the vehicle, year when the vehicle was made, engine type, displacement, and accumulated driving distance. The driver-vehicle allocation details include the vehicle ID, the driver's ID, driving start time, and driving finished time. Further, the vehicle trouble code includes information such as trouble code and description of the trouble. Further, the device connection status includes information about reception time, status of terminal storing space, connection status of the information collecting unit, GPS connection status, and terminal-server connection status.

The basic vehicle information screen 610 displays vehicle status information, vehicle driving information, and vehicle diagnosis information. The vehicle status information includes the vehicle ID status information collecting time, voltage of the battery, and temperature of the cooling liquid. The vehicle driving information includes the vehicle ID, a time for collecting the driving information, positional information (longitude/latitude), speed information, RPM information, and fuel spraying time. Further, the vehicle diagnosis information includes the vehicle ID, the ID, diagnosis information collecting time, and error code.

The analyzed vehicle information screen 630 displays driving tendency statistics information, driving history information and expendable supply replacement information. The driving tendency statistics information includes information about the vehicle ID, the driver's ID, the driving start time, the driving finish time, driving time, driving time per speed, the frequency of sudden acceleration, the frequency of sudden speed reduction, the period of the idle status, and the amount of consumed fuel. The driving history information includes information about the vehicle ID, the driver's ID, the driving start time, the driving finish time, the driving start position, the driving finish position, a total driving distance, a total driving time, and the amount of consumed fuel. Further, the expendable supply replacement information includes information about the vehicle ID, an expendable supply ID, the replacement time, the replacement, and the accumulated distance when the replacement is performed.

Finally, the information screen according to the driving distance 640 displays information about the vehicle ID, the collection start time, the collection finish time, the driving distance, the idle status, the frequency of sudden acceleration, the frequency of sudden speed reduction, the accelerated time, and the driving index.

The exemplary embodiment of the present invention that has been described above may be implemented by not only an apparatus and a method but also a program capable of realizing a function corresponding to the structure according to the exemplary embodiment of the present invention and a recording medium having the program recorded therein. It can be understood by those skilled in the art that the implementation can be easily made from the above-described exemplary embodiment of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of managing vehicle and driver information, comprising:
receiving a plurality of internal status information and external environment information of a vehicle, and driver's behavior information, collected by an information collecting unit;
storing the plural pieces of information by applying a driver's behavior model and a behavior rule previously stored in the received internal status information and external environment information of a vehicle, and the driver's behavior information;
transmitting the stored information to an observation center and calculating driver's workload on the basis of the stored information; and
estimating and managing situation information of the driver and the vehicle on the basis of the calculated driver's workload.

2. The method of claim 1, wherein the storing of the plural pieces of information comprises:
selecting information having a predetermined characteristic (which affects the driver) from the received internal status information and the external environment information of a vehicle, and the driver's behavior information;
applying the driver's behavior model and the behavior rule to the selected information; and
storing the selected information to which the driver's behavior model and the behavior rule are applied.

3. The method of claim 1, wherein the estimating and managing comprises:
numerically calculating the driver's workload and the current driver's behavior information to compare them;
when the numerically calculated driver's behavior information is lower than that of the driver's workload, informing the driver's situation information to the driver; and
comparing the value of numerically calculated vehicle external environment information with the driver's workload to estimate and manage driver attention information to be provided to the driver.

4. The method of claim 1, further comprising:
creating a message including the internal status information and the external environment information of a vehicle, the driver's behavior information, vehicle diagnosis information, and vehicle driving information (herein, the vehicle diagnosis information and the vehicle driving information are calculated from the internal status information and the external environment information of a vehicle, and the driver's behavior information);
transmitting the created message to the observation center; and
if an acknowledgement message is not received from the observation within a predetermined time, retransmitting the created message.

5. The method of claim 4, wherein the vehicle internal information includes at least one of vehicle electronic control unit information and transmission information that are collected by the information collecting unit.

6. The method of claim 4, wherein the vehicle external environment information includes at least one of weather information, road information, traffic information, and time information.

7. A method of managing vehicle and driver information, comprising:
receiving a plurality of internal status information and external environment information of a vehicle, and driver's behavior information, which are collected by an information collecting unit and then stored, from a terminal;
creating a driver's behavior model on the basis of the received information; and
creating a driver's behavior model and vehicle driving rules on the basis of the received information.

8. The method of claim 7, further comprising
transmitting the created driver's behavior model and the driving rules to the terminal.

9. The method of claim 8, further comprising:
creating a message including the driver's behavior model and the driving rules;
transmitting the created message to a terminal;
determining whether an acknowledgement message is received from the terminal within a predetermined time; and
if the acknowledgement message is not received, retransmitting the created message.

10. A system of managing vehicle and driver information, comprising:
an information filtering module that calculates information having a predetermined characteristic among a plurality of internal status information and external environment information of a vehicle, and driver's behavior information collected by an information collecting unit;
an information storing module that stores the calculated information;
a driver's workload calculating module that calculates driver's workload using the stored information;
a situation information estimating module that compares the calculated driver's workload with the value of numerically calculated driver's behavior information to provide the driver's situation information and compares the vehicle external environment information with the numerically calculated value to estimate the driver attention information; and
a driver attention information supply module that receives the estimated driver attention information to display to the driver.

11. A system of managing vehicle and driver information, comprising:
a terminal information managing module that receives internal status information and external environment information of a vehicle, and driver's behavior information, collected by an information collecting unit and transmitted from a terminal;
an information storing module that stores the received vehicle internal status information, the vehicle external environment, and driver's behavior information;
a driving rule creating module that creates and updates the driver's driving tendency and a driving rule on the basis of the information stored in the information storing module;
a driver's behavior model creating module that calculates a driving pattern that influences a driver's workload on the basis of the information stored in the information storing module and creates the driver's behavior model on the basis of the driving pattern; and
a management information supply module that extracts the driver's driving tendency information requested by the driver to display to the driver.

12. The system of claim 10, wherein the information collecting unit comprises:
a vehicle internal status information collecting unit that collects at least one of vehicle engine information, transmission information, and motor information that are collected by at least one of an electronic control unit and a transmission control unit;
a vehicle external environment information collecting module that collects at least one of weather information, traffic accident information, traffic information, or time information; and
a driver's behavior information collecting module that collects at least one of sleepiness of a driver, use of a portable phone, conversation with a fellow passenger, or forward observation.
